(19) United States
(12) Patent Application Publication
(10) Pub. No.: US 2015/0002519 A1
(43) Pub. Date: Jan. 1, 2015

(54) CONTROL SYSTEM AND METHOD FOR LIGHTING UP SCREEN OF ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YANG WANG, Shenzhen (CN); JUN-JUAN GAO, Shenzhen (CN); XIAO-WEI YANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/010,545

(22) Filed: Aug. 27, 2013

(30) Foreign Application Priority Data
Jun. 27, 2013 (CN) 2013102622936

(51) Int. Cl. G09G 5/10

(52) U.S. Cl. CPC G09G 5/10
USPC 345/502

(57) ABSTRACT

A control system for lighting up a screen of an electronic device is provided to decrease the length of user waiting time before activation of an electronic device. The device includes a state register. The state register is switched between a ready state and a non-ready state. The control system includes a detecting module, a first controlling module, and a second controlling module. The detecting module detects a ready or a non-ready state of the device. The first controlling module implements startup operations when the register is not in the ready state. The second controlling module lights up the screen when the state register is in the ready state. An electronic device and a method for lighting up the screen are also provided.

### BACKGROUND

1. Technical Field

The present disclosure relates to control systems, and particularly to a control system and a method for lighting up a screen of an electronic device.

2. Description of Related Art

Before the activation of electronic devices, the electronic device will detect whether or not the device is in a ready state, and if so, the electronic device will light up a screen and then implement startup operations. If not, the electronic device will repeat the above step to detect readiness again and again until readiness is detected. If duration of the readiness-detecting function is lengthy, this will result in a longer time for starting up the electronic device.

Therefore, what is needed is a control system for lighting up a screen to overcome the above described limitations.

### BRIEF DESCRIPTION OF THE DRAWING

FIG. 1 is a block diagram of a control system for lighting up a screen of an electronic device in accordance with an exemplary embodiment.

FIG. 2 is a flowchart of screen lighting up method implemented by the control system of FIG. 1.

### DETAILED DESCRIPTION

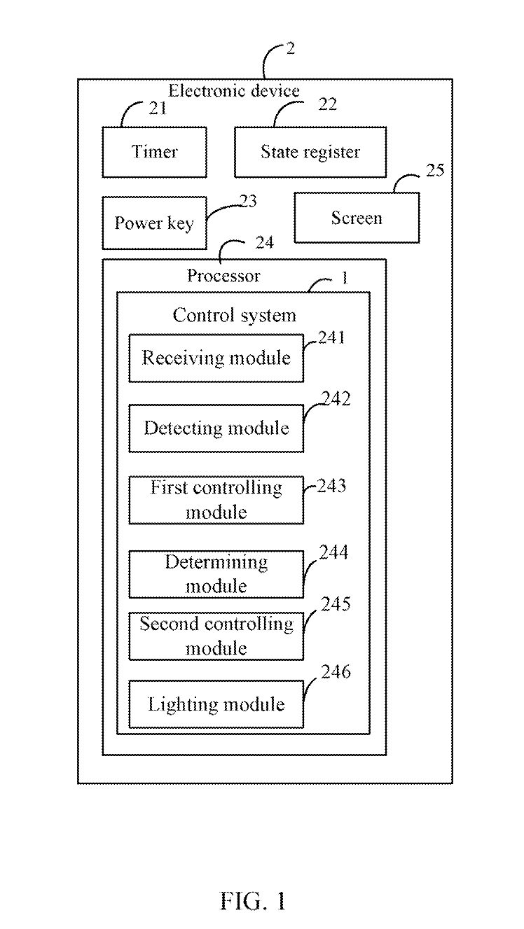

FIG. 1 shows a control system 1 for lighting up a screen 25 of an electronic device 2. The control system 1 runs in the electronic device 2 and controls the electronic device 2 to light up the screen 25. The electronic device 2 includes a timer 21, a state register 22, and a processor 24. The timer 21 records time passing. The state register 22 of the electronic device 2 can be switched between a ready state and a non-ready state. In one embodiment, the register 22 is a register for indicating the ready state and the non-ready state. The ready state allows activation but the non-ready state does not allow activation.

The processor 24 includes a detecting module 242, a first controlling module 243, a second controlling module 245, and a determining module 244 which is collection of software instructions for execution by the processor 24.

The detecting module 242 detects whether or not the state register 22 is in the ready state in response to an instruction which is instructed hereinafter. The second controlling module 245 controls the electronic device 2 to light up the screen 25 when the state register 22 is in the ready state. The first controlling module 243 controls the electronic device 2 to implement startup operations, and controls the timer 21 to start timing when the state register 22 is in the not-ready state. The determining module 244 determines whether or not duration of time recorded by the timer 21 reaches a predetermined duration of time. The detecting module 242 further detects whether or not the state register 22 is in the ready state when the duration recorded by the timer 21 reaches the predetermined duration. In one embodiment, the predetermined duration is milliseconds (20 ms).

The processor 24 further includes a lighting module 246. The lighting module 246 controls the electronic device 2 to light up the screen 25 after the electronic device 2 has finished startup operations even if the state register 243 is in the not-ready state, thereby avoiding the continuous detection of the state of the state register 22.

In one embodiment, the electronic device 2 further includes a first timer (not labeled) for starting to time when starting up the electronic device 2, to obtain a first duration of time. The determining module 244 determines whether or not the first duration reaches a first predetermined duration. If the first duration reaches the first predetermined duration, it signifies that the electronic device 2 has finished startup operations. Otherwise, the electronic device 2 is deemed not to finished startup operations.

The electronic device 2 further includes a power key 23. The processor 24 further includes a receiving module 241 which is collection of software instructions for execution by the processor 24. The receiving module 241 receives an operation on the power key 23 to the instruction.

The first controlling module 243 further controls the timer 21 to reset when the duration recorded by the timer 21 reaches the predetermined duration.

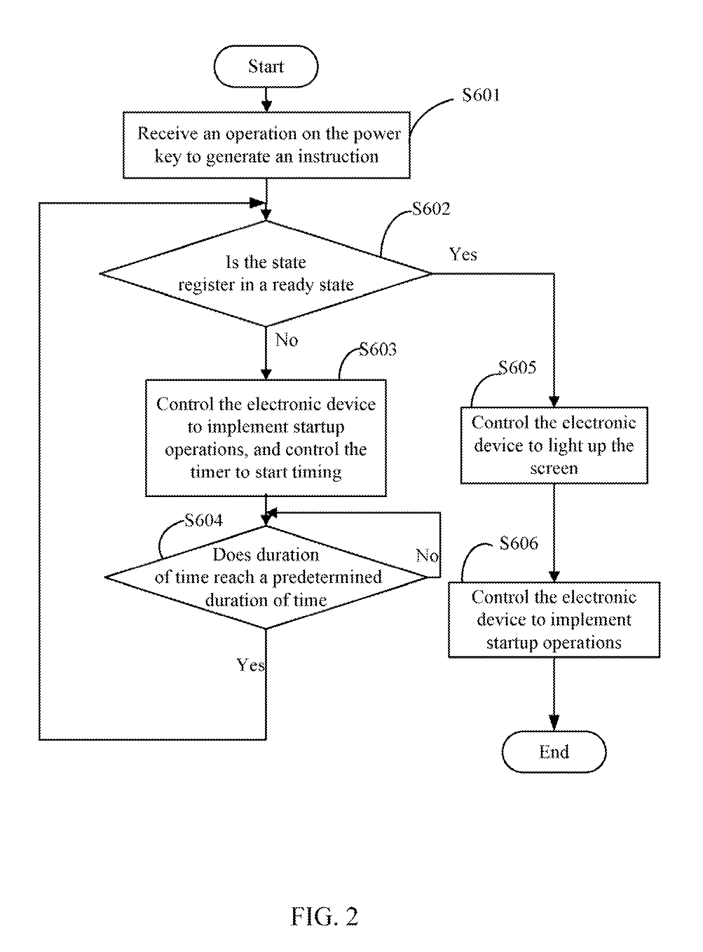

FIG. 2 is a flowchart of screen lighting up method implemented by the control system of FIG. 1.

In step S601, the receiving module 241 receives an operation on the power key 23 to generate the instruction.

In step S602, the detecting module 242 detects whether or not the state register 22 is in the ready state, if yes, the procedure goes to step S605, if no, the procedure goes to step S603.

In step S603, the first controlling module 243 controls the electronic device 2 to implement startup operation, and controls the timer 21 to start timing.

In step S604, the determining module 244 determines whether or not the duration of time recorded by the timer 21 reaches the predetermined duration of time, if yes, the procedure goes to step S602, if no, the procedure goes to step S604.

In step S605, the second controlling module 245 controls the electronic device 2 to light up the screen 25.

In step S606, the first controlling module 243 controls the electronic device 2 to implement startup operations.

The method further includes sub-step: the lighting module 246 controls the electronic device 2 to light up the screen 25 after the electronic device 2 has finished the startup operations even if the state register 243 is in the not-ready state.

The method further includes sub-step: the first controlling module 243 controls the timer 21 to reset when the duration recorded by the timer 21 reaches the predetermined duration.

Although various embodiments have been specifically described, the disclosure is not to be construed as being limited thereto. Various changes or modifications may be made to the embodiments without departing from the scope and spirit of the disclosure.

What is claimed is:

1. A control system for lighting up a screen of an electronic device, wherein the electronic device comprises a state register, the state of the state register is switched between a ready state and a non-ready state, the control system comprising:
at least one processor; and
a plurality of modules to be executed by the at least one processor, wherein the plurality of modules comprises:
a detecting module configured to detect whether or not the state register is in the ready state;
a first controlling module configured to control the electronic device to implement startup operations when the state register is in the not-ready state; and
a second controlling module configured to control the electronic device to light up the screen when the state register is in the ready state.

2. The control system as described in claim 1, wherein the first controlling module is further configured to control a timer of the electronic device to start timing when the state register is not in the ready state, the plurality of modules further comprise:
a determining module configured to determine whether or not the duration of time reaches a predetermined duration of time;
wherein the detecting module is further configured to detect whether or not the state register is in the ready state when the duration of time reaches the predetermined duration of time, and the first controlling module is further configured to control the timer to reset when the duration of time reaches the predetermined duration of time.

3. The control system as described in claim 1, wherein the plurality of modules further comprise a lighting module, the lighting module is configured to control the electronic device to light up the screen after the electronic device has finished the startup operations even if the state register is in the not-ready state.

4. An electronic device for lighting up a screen comprising:
a state register being switched between a ready state and a non-ready state; and
a processor configured to detect whether or not the state register is in the ready state, control the electronic device to implement startup operations when the state register is in the not-ready state, and control the electronic device to light up the screen when the state register is in the ready state.

5. The electronic device as described in claim 4, further comprising a timer, wherein the processor is further configured to control the timer to start timing when the state register is not in the ready state, determine whether or not the duration of time reaches a predetermined duration of time, detect whether or not the state register is in the ready state when the duration of time reaches the predetermined duration of time, and control the timer to reset when the duration reaches the predetermined duration.

6. The electronic device as described in claim 4, wherein the processor is further configured to control the electronic device to light up the screen after the electronic device has finished the startup operations even if the state register is in the not-ready state.

7. A method for lighting up a screen of an electronic device, wherein the electronic device comprises a state register, the state of the state register is switched between a ready state and a non-ready state, the method comprising:
detecting whether or not the state register is in the ready state;
controlling the electronic device to implement startup operations when the state register is in the not-ready state; and
controlling the electronic device to light up the screen when the state register is in the ready state.

8. The method as described in claim 7, further comprising:
controlling a timer of the electronic device to start timing when the state register is not in the ready state;
determining whether or not the duration of time reaches a predetermined duration of time;
detecting whether or not the state register is in the ready state when the duration of time reaches the predetermined duration of time; and
controlling the timer to reset when the duration of time reaches the predetermined duration of time.

9. The method as described in claim 7, further comprising:
controlling the electronic device to light up the screen after the electronic device has finished the startup operations even if the state register is in the not-ready state.
